(19) United States
(12) Patent Application Publication
(10) Pub. No.: US 2026/0071039 A1
(43) Pub. Date: Mar. 12, 2026

(54) FLAME RETARDANT FOAM, METHOD OF MANUFACTURE, AND ARTICLES USING THE SAME

(71) Applicant: ROGERS CORPORATION, Chandler, AZ (US)

(72) Inventors: Joseph Puglisi, Ashford, CT (US); An Le, Tolland, CT (US)

(21) Appl. No.: 19/318,606

(22) Filed: Sep. 4, 2025

Related U.S. Application Data
(60) Provisional application No. 63/692,450, filed on Sep. 9, 2024.

(51) Int. Cl. C08J 9/06; C08J 9/12; C08K 3/04; C08K 3/32

(52) U.S. Cl. CPC C08J 9/06; C08J 9/12; C08K 3/04; C08K 3/32; C08J 2367/02; C08J 2471/02; C08K 2003/323

(57) ABSTRACT

A flame retardant foam including polyurethane; and flame retardant additives, wherein the flame retardant foam has a density of 8 to less than 11.7 pounds per cubic foot (128 to less than 187 kilograms per cubic meter), a thickness of 2.7 to 8 millimeters, or 2.8 to 8 millimeters, or 3 to 8 millimeters, and a UL 94 rating of V-0.

### CROSS-REFERENCE TO RELATED APPLICATION

This application claims priority to U.S. Provisional Patent Application No. 63/692,450, filed on Sep. 9, 2024, the contents of which are hereby incorporated by reference in their entirety.

### BACKGROUND

This application relates to a flame retardant foam, in particular a flame retardant polymer foam, a method of preparing the flame retardant foam, and uses thereof.

Polymer foams have a wide variety of uses in the art. Compressible (as opposed to rigid) foams are particularly useful for cushioning and impact protection, particularly in electronic devices. As the demand for smaller, thinner, and more compact devices has increased, so has the demand for lower density, e.g., softer, polymer foams, for example, foams having a density of 200 kilograms per cubic meter (kg/m³) or less and a thickness of less than 8 millimeters (mm), less than 7 mm, or even less than 6 mm. However, it has been difficult to produce foams of this thickness that still meet the stringent requirements for good cushioning properties, such as good compression set, and good flame retardance. These properties are important in handheld electronic devices, as well as electronic devices such as televisions, radios, computers, medical instruments, business machines, communications equipment, and the like. The increasing power of such devices has made obtaining flame retardance even more challenging, due to increased heat being generated within ever smaller spaces.

Accordingly, there remains a need in the art for lightweight foams that are thin, that provide good cushioning to minimize shock or vibration, and that can provide good flame retardance, for example, a UL-94 rating of V-0 at a thickness of 8 mm or less.

### BRIEF SUMMARY

In an aspect, a flame retardant foam includes polyurethane and flame retardant additives, wherein the flame retardant foam has a density of 8 to less than 11.7 pounds per cubic foot (1b/ft³) (128 to less than 187 kg/m³), a thickness of 2.7 to 8 mm, or 2.8 to 8 mm, or 3 to 8 mm, and a UL 94 rating of V-0.

In an aspect, a method of forming the flame retardant foam includes combining an active hydrogen-containing component including a polyol, an isocyanate component including a polyisocyanate, and the flame retardant additives to form an uncured polyurethane foam; and curing the uncured polyurethane foam to form the flame retardant foam.

The above-described and other features are exemplified by the following detailed description, examples, and claims.

### DETAILED DESCRIPTION

The present inventors have discovered that very thin, flame retardant foams with good cushioning properties and flame retardance can be produced using flame retardant additives including graphite, ammonium polyphosphate, and optionally liquid phosphate flame retardant (referred to collectively herein as “the disclosed flame retardant additives”). Desirable flame retardance can be achieved for very thin foams with low overall density and good compression properties.

Without wishing to be bound by any theory, it is believed that the graphite, an intumescent filler, can expand into a low density, thermally insulating char when burned. And the ammonium polyphosphate and optional liquid phosphate flame retardant, char promoters, can improve structural integrity of the char. Creating a char with good structural integrity can help prevent the sample from breaking during UL-94 V-0 burn testing, which would result in failure.

A method of forming a cured polyurethane flame retardant foam includes combining an active hydrogen-containing component (also referred to herein as “Part A”) including a polyol and an isocyanate component (also referred to herein as “Part B”) including a polyisocyanate and the disclosed flame retardant additives to form an uncured polyurethane foam; and curing the uncured polyurethane foam to form the cured polyurethane foam. The method can further include mechanically frothing the uncured polyurethane foam. In an aspect, the flame retardant foam consists essentially of, or consists of the cured polyurethane foam.

The polyurethane flame retardant foam further includes a plurality of openings, i.e., pores. The pores are defined by an inner surface of the foam. The pores can be interconnected or discrete. A combination of interconnected and discrete pores can be present. The pores can be wholly contained within the sheet, or at least a portion of the pores can be open to a surface of the sheet, allowing communication with the surrounding environment. In an aspect, at least a portion of the pores are interconnected and at least a portion of the pores are open, allowing passage of air, water, water vapor, or the like from a first outer surface to an opposite second outer surface, referred to herein as an “open-celled foam”. In an aspect, the foam can be a “closed cell foam”, where the pores may or may not interconnect, and are substantially not open to a surface of the sheet, or are completely closed, such that the sheet does not allow substantial passage of air, water, water vapor, or the like from one outer surface to the other outer surface. In an aspect, the foam is a substantially closed-cell foam, or a completely closed-cell foam.

The disclosed flame retardant additives are distributed within the polyurethane flame retardant foam. The disclosed flame retardant additives can be distributed essentially uniformly, or as a gradient, for example, increasing from a first outer surface in the direction of a second outer surface. As used herein, the phrase “disposed within” can mean that the disclosed flame retardant additives is distributed within the matrix of the polyurethane flame retardant foam. Further as used herein, the phrase “disposed within” can mean that the disclosed flame retardant additives can be located within a pore of the polyurethane flame retardant foam, for example, coating an inner surface of the foam, or located within the pore. A portion of the number of pores in the polyurethane flame retardant foam can contain the disclosed flame retardant additives, or essentially all, or all of the pores can contain the disclosed flame retardant additives. Each pore containing the disclosed flame retardant additives can independently be partially filled, essentially fully filled, or fully filled.

The disclosed flame retardant additives can be incorporated into the polyurethane foam during manufacture thereof. As described herein, the disclosed flame retardant additives can be located within the polyurethane matrix of the polyurethane flame retardant foam, within a pore of the polyurethane flame retardant foam, or both. A portion of the number of pores in the polyurethane flame retardant foam can contain the disclosed flame retardant additives, or essentially all, or all of the pores can contain the disclosed flame retardant additives. Each pore containing the disclosed flame retardant additives can independently be partially filled, essentially fully filled, or fully filled. In an aspect in which particles of the disclosed flame retardant additives are large relative to a diameter of the pore, or the pore is essentially or fully filled with a plurality of smaller particles of the disclosed flame retardant additives, movement of the disclosed flame retardant additives within the pore can be restricted. The disclosed flame retardant additives can be located in the pores during manufacture of the foam (for example, by including the disclosed flame retardant additives in the composition used to form the polyurethane flame retardant foam), or the disclosed flame retardant additives can be impregnated into the pores after manufacture of the polyurethane flame retardant foam using a suitable liquid carrier, vacuum, or other suitable method.

A combination of different placements can be used. For example, the disclosed flame retardant additives within a pore of the polyurethane flame retardant foam can be used in combination with the disclosed flame retardant additives distributed within the polyurethane flame retardant foam.

In an aspect, most, essentially all, or all, of particles of the disclosed flame retardant additives have a largest dimension less than the thickness of the foam or the pore in which they are located, to provide a smooth surface to the foam. The particular diameters used therefore depend on the location of particles of the disclosed flame retardant additives. Bi-, tri-, or higher multimodal distributions of particles of the disclosed flame retardant additives can be used. For example, when the disclosed flame retardant additives is present within the matrix of the polyurethane flame retardant foam and within the pores of the polyurethane flame retardant foam, a bimodal distribution of particles of the disclosed flame retardant additives can be present.

The disclosed flame retardant foam can have a density of 8 to less than 11.7 1b/ft³ (128 to less than 187 kg/m³); a thickness of 2.7 to 8 mm, or 2.8 to 8 mm, or 3 to 8 mm, and a UL 94 rating of V-0. For example, the flame retardant foam can have a density of 9 to 11 1b/ft³ (144 to 176 kg/m³); the flame retardant foam can have a density of 9.0 to 10.9 1b/ft³ (144 to 175 kg/m³); the flame retardant foam can have a density of 9.4 to 10.9 1b/ft³ (151 to 175 kg/m³); the flame retardant foam can have a density of 9.8 to 10.9 lb/ft³ (156 to 175 kg/m³); the flame retardant foam cam have a density of 8 to less than 9.9 lb/ft³ (128 to less than 159 kg/m³); the flame retardant foam can have a density of 9.0 to 9.8 lb/ft³ (144 to 157 kg/m³); the flame retardant foam can have a density of 9.2 to 9.8 lb/ft³ (147 to 157 kg/m³); the flame retardant foam can have a thickness of 2.7 to 7.5 mm, or 2.8 to 7.5 mm, or 3.5 to 7.5 mm; the flame retardant foam can have a thickness of 4.1 to 7.5 mm; the flame retardant foam can have a thickness of 4.5 to 7.5 mm; the flame retardant foam can have a thickness of 2.7 to 4 mm, or 2.8 to 4 mm, or 3.5 to 4 mm; the flame retardant foam can have a thickness of 2.7 to 7 mm, or 2.8 to 7 mm, or 4.1 to 7 mm; the flame retardant foam can have a thickness of 5 to 7 mm; the flame retardant foam can have a thickness of 2.7 to 6.3 mm, or 2.8 to 6.3 mm, or 5.8 to 6.3 mm; the flame retardant foam can have a thickness of 2.7 to 6 mm, or 2.8 to 6 mm, or 3.5 to 6 mm the flame retardant foam can have a thickness of 4 to 6 mm; the flame retardant foam can have a density of 9.0 to 10.9 1b/ft³ (144 to 175 kg/m³) or 9.8 to 10.9 lb/ft³ (157 to 175 kg/m³) and a thickness of 2.7 to 6.3 mm, or 2.8 to 6.3 mm, or 5.8 to 6.3 mm; the flame retardant foam can have a density of 9.0 to 10.9 1b/ft³ (144 to 175 kg/m³) or 9.4 to 10.9 1b/ft³ (151 to 175 kg/m³) and a thickness of 2.7 to 6.3 mm, or 2.8 to 6.3 mm, or 3.5 to 6.3 mm, or 4.2 to 6.3 mm; the flame retardant foam can have a density of 8 to 9.8 lb/ft³ (128 to 157 kg/m³); the flame retardant foam can have a density of 9.0 to 9.8 lb/ft³ (144 to 157 kg/m³) or 9.2 to 9.8 lb/ft³ (147 to 157 kg/m³) and a thickness of 3.5 to 6 mm, or 4 to 6 mm; or a combination thereof.

The graphite can be an expandable graphite having a size of, for example, 50 to 80 mesh, and, for example, 180 to 250° C. onset temperature for expansion. Graphite is available from manufacturers such as AMG Graphite, Asbury Carbons, Carbon Graphite Materials Inc., Graphite Central, M Chemical, Neograf Solutions, Senhui Corporation, and Shijiazhuang ADT Carbonic Material. The graphite can be present in the uncured polyurethane foam in an amount of 5 to 30 weight percent (wt %), or 10 to 20 wt %, or 14 to 18 wt %, based on a total weight of the uncured polyurethane foam.

The ammonium polyphosphate can be uncoated or coated with, for example, melamine or silane, and have a particle size of, for example, 7 to 20 μm. Ammonium polyphosphate is available from manufacturers such as Asheville Lubricants, Budenheim, ChemCeed, Clariant, M Chemical, Hangzhou JLS Flame Retardants Chemical Co., Mei Wang Chemical, Shandong Changsheng New Flame Retardant Co., and St. Louis Group. The ammonium polyphosphate can be present in the uncured polyurethane foam in an amount of 5 to 30 wt %, or 5 to 20 wt %, or 10 to 15 wt %, based on a total weight of the uncured polyurethane foam.

The liquid phosphate flame retardant can include, for example, phenol, isobutylenated, phosphate (3:1) with 2.5 to 25 wt % of triphenyl phosphate. Liquid phosphate flame retardant is available from manufacturers such as ICL, Lanxess, and St. Louis Group. The liquid phosphate flame retardant can be present in the uncured polyurethane foam in an amount of 0.1 to 15 wt %, or 0.5 to 10 wt %, or 1 to 5 wt %, or 1 to 3 wt %, or 0.1 to 3 wt %, based on a total weight of the uncured polyurethane foam. As the liquid phosphate flame retardant is optional, the uncured polyurethane foam can include 0 wt % of liquid phosphate flame retardant, based on a total weight of the uncured polyurethane foam.

The flame retardant foam can include only non-halogenated flame retardants, i.e., 0 wt % halogenated flame retardants. Non-halogenated flame retardants can be desirable due to, for example, toxicity and environmental impact concerns associated with halogenated flame retardants.

The flame retardant foam can be manufactured from polyurethane foam-forming compositions. The graphite, ammonium polyphosphate, and optional liquid phosphate flame retardant can be incorporated into the polyurethane foam-forming composition before the polyurethane is foamed and cured.

The polyurethane foams can be formed from a reactive composition comprising an organic isocyanate-containing component reactive with an active hydrogen-containing composition, a surfactant, a catalyst, and the above filler components. Each of the organic isocyanate component and the active hydrogen-containing component can include one or more different types of each type of compound.

The organic polyisocyanate component used in the preparation of polyurethane foams comprises at least a polyisocyanate having the general formula Q(NCO)ᵢ, wherein i is an integer having an average value of two or greater, and Q is an organic radical having a valence of i. Q can be a substituted or unsubstituted group (for example, an alkane or an aromatic group of the appropriate valency). Q can be a group having the formula Q¹-Z-Q¹ wherein Q¹ is an alkylene or arylene group and Z is —O—, —O-Q¹-S—, —CO—, —S—, —S-Q¹-S—, —SO—, or —SO₂—. Q can represent a polyurethane radical having a valence of i.

Examples of suitable polyisocyanates include hexamethylene diisocyanate, 1,8-diisocyanato-p-methane, xylyl diisocyanate, diisocyanatocyclohexane, phenylene diisocyanates, tolylene diisocyanates, including 2,4-tolylene diisocyanat, 2,6-tolylene diisocyanate, and crude tolylene diisocyanate, bis(4-isocyanatophenyl) methane, chlorophenylene diisocyanates, diphenylmethane-4,4′-diisocyanate (also known as 4,4′-diphenyl methane diisocyanate, or MDI) and adducts thereof, naphthalene-1,5-diisocyanate, triphenylmethane-4,4′,4″-triisocyanate, isopropylbenzene-alpha-4-diisocyanate, or polymeric isocyanates such as polymethylene polyphenylisocyanatc.

The active hydrogen-containing component includes at least one multi-functional active hydrogen containing compound, which can be a polyamine or a polyol, for example, a polyether polyol, a polyester polyol, a lower molecular weight polyol, or a combination thereof. Suitable polyester polyols are inclusive of polycondensation products of polyols with dicarboxylic acids or ester-forming derivatives thereof (such as anhydrides, esters and halides), polylactone polyols obtainable by ring-opening polymerization of lactones in the presence of polyols, polycarbonate polyols obtainable by reaction of carbonate diesters with polyols, or castor oil polyols. Suitable dicarboxylic acids and derivatives of dicarboxylic acids that are useful for producing polycondensation polyester polyols are aliphatic or cycloaliphatic dicarboxylic acids such as glutaric, adipic, sebacic, fumaric or maleic acids; dimeric acids; aromatic dicarboxylic acids such as phthalic, isophthalic or terephthalic acids; tribasic or higher functional polycarboxylic acids such as pyromellitic acid; as well as anhydrides or second alkyl esters, such as maleic anhydride, phthalic anhydride or dimethyl terephthalate. The polymers of cyclic esters can also be used. The preparation of cyclic ester polymers from at least one cyclic ester monomer is exemplified by U.S. Pat. Nos. 3,021,309 through 3,021,317; 3,169,945; and 2,962,524. Suitable cyclic ester monomers include but are not limited to 8-valerolactone; E-caprolactone; zeta-enantholactone; the monoalkyl-valerolactones, e.g., the monomethyl-, monoethyl-, and monohexyl-valerolactones. In general the polyester polyol may comprise a caprolactone-based polyester polyol, an aromatic polyester polyol, an ethylene glycol adipate-based polyol, or a combination thereof. Polyester polyols made from E-caprolactones, adipic acid, phthalic anhydride, and terephthalic acid or dimethyl esters of terephthalic acid are generally preferred.

Polyether polyols can be obtained by the chemical addition of alkylene oxides, such as ethylene oxide, propylene oxide, or a combination thereof, to water or polyhydric organic components, such as ethylene glycol, propylene glycol, trimethylene glycol, 1,2-butylene glycol, 1,3-butanediol, 1,4-butanediol, 1,5-pentanediol, 1,2-hexylene glycol, 1,10-decanediol, 1,2-cyclohexanediol, 2-butene-1,4-diol, 3-cyclohexene-1,1-dimethanol, 4-methyl-3-cyclohexene-1,1-dimethanol, 3-methylene-1,5-pentanediol, diethylene glycol, (2-hydroxyethoxy)-1-propanol, 4-(2-hydroxyethoxy)-1-butanol, 5-(2-hydroxypropoxy)-1-pentanol, 1-(2-hydroxymethoxy)-2-hexanol, 1-(2-hydroxypropoxy)-2-octanol, 3-allyloxy-1,5-pentanediol, 2-allyloxymethyl-2-methyl-1,3-propanediol, [4,4-pentyloxy)-methyl]-1,3-propanediol, 3-(o-propenylphenoxy)-1,2-propanediol, 2,2′-diisopropylidencbis(p-phenylencoxy)dicthanol, glycerol, 1,2,6-hexanetriol, 1,1,1-trimethylolethane, 1,1,1-trimethylolpropane, 3-(2-hydroxyethoxy)-1,2-propanediol, 3-(2-hydroxypropoxy)-1,2-propancdiol, 2,4-dimethyl-2-(2-hydroxyethoxy)-methylpentanediol-1,5; 1,1,1-tris[2-hydroxyethoxy)methyl]-cthane, 1,1,1-tris[2-hydroxypropoxy)-methyl|propane, diethylene glycol, dipropylene glycol, pentaerythritol, sorbitol, sucrose, lactose, alpha-methylglucoside, alpha-hydroxyalkylglucoside, a novolac polymer, phosphoric acid, benzenephosphoric acid, a polyphosphoric acid such as tripolyphosphoric acid and tetrapolyphosphoric acid, ternary condensation products, and the like. The alkylene oxides used in producing polyoxyalkylene polyols can have 2 to 4 carbon atoms, or 2 to 3 carbon atoms. Exemplary alkylene oxides are propylene oxide and mixtures of propylene oxide with ethylene oxide. Polytetramethylene polyether diol or glycol, and mixture with one or more other polyols, can be specifically mentioned. The polyols listed above can be used per se as the active hydrogen component.

A specific class of polyether polyols is represented generally by the formula R[(OCₙH₂ₙ)_{z}OH]ₐ wherein R is hydrogen or a polyvalent hydrocarbon radical; a is an integer (i.e., 2 to 8) equal to the valence of R, n in each occurrence is an integer from 2 to 4 inclusive (preferably 3) and z in each occurrence is an integer having a value of 2 to 200, preferably 15 to 100. Specifically, the polyether polyol can have the formula R[(OC₄H₈)_{z}OH]₂, wherein R is a divalent hydrocarbon radical and z in each occurrence is 2 to about 40, specifically 5 to 25.

Another type of active hydrogen-containing material that can be used is a polymer polyol composition obtained by polymerizing ethylenically unsaturated monomers with a polyol as described in U.S. Pat. No. 3,383,351, the disclosure of which is incorporated herein by reference. Suitable monomers for producing such compositions include acrylonitrile, vinyl chloride, styrene, butadiene, vinylidene chloride, and other ethylenically unsaturated monomers as identified and described in the above-mentioned U.S. Patent. Suitable polyols include those listed and described above and in U.S. Pat. No. 3,383,351. The active hydrogen-containing component may also contain polyhydroxy-containing compounds such as hydroxyl-terminated polyhydrocarbons (U.S. Pat. No. 2,877,212); hydroxyl-terminated polyformals (U.S. Pat. No. 2,870,097); fatty acid triglycerides (U.S. Pat. Nos. 2,833,730 and 2,878,601); hydroxyl-terminated polyesters (U.S. Pat. Nos. 2,698,838, 2,921,915, 2,591,884, 2,866,762, 2,850,476, 2,602,783, 2,729,618, 2,779,689, 2,811,493, 2,621,166 and 3,169,945); hydroxymethyl-terminated perfluoromethylenes (U.S. Pat. Nos. 2,911,390 and 2,902,473); hydroxyl-terminated polyalkylene ether glycols (U.S. Pat. No. 2,808,391; British Patent No. 733,624); hydroxyl-terminated polyalkylencarylene ether glycols (U.S. Pat. No. 2,808,391); and hydroxyl-terminated polyalkylene ether triols (U.S. Pat. No. 2,866,774).

The active-hydrogen-containing component, in particular the polyol component, can further include a very low molecular weight chain extender, cross-linking agent, or combination thereof. Exemplary chain extenders and cross-linking agents include alkane diols, dialkylene glycols and/or polyhydric alcohols, preferably triols and tetrols, having a molecular weight from about 200 to 400 Dalton. The chain extenders and cross-linking agents can be used, for example, in an amount of 0.5 to 20 percent by weight, or 10 to 15 percent by weight, based on the total weight of the active-hydrogen-containing component. Other chain extenders can be a very low molecular weight (below about 200 Dalton)diol, including but not being limited to, dipropylene glycol, 1,4-butanediol, 2-methyl-1,3-propanediol, and 3-methyl-1,5-pentane diol.

In an embodiment, the active hydrogen-containing component is a polyol component that comprises a higher molecular weight polyether polyol, for example, a polyether polyol having a weight average molecular weight (Mw) of 500 to about 4,000, or 1,000 and 3,000, and a hydroxy number of 10 to 200; a polyester polyol, such as a polycaprolactone-based polyol, or a combination thereof, and a very low molecular weight polyol as a chain extender or crosslinking agent. Exemplary polyether polyols include polyoxyalkylene diols and triols, and polyoxyalkylene diols and triols with polystyrene and/or polyacrylonitrile grafted onto the polymer chain, or a combination thereof. A triol can be present, such as a polycaprolactone triol having an Mw of 50 to 3,000 and a hydroxy number can be 200 to 2,000, preferably 500 to 1500. A preferred triol is a polycaprolactone triol.

In general, the average weight percent hydroxy, based on the hydroxyl numbers of the hydroxyl-containing compounds (including all polyols or diols), including other cross-linking additives, fillers, surfactants, catalysts, and pigments, if used, can be 500 to 400, depending on the desired firmness or softness of the polyurethane. The hydroxyl number is defined as the number of milligrams of potassium hydroxide required for the complete neutralization of the hydrolysis product of the fully acetylated derivative prepared from 1 gram of polyol or polyol component with or without other cross-linking additives.

A number of catalysts can be used to catalyze the reaction of the isocyanate component with the active hydrogen-containing component. The amount of catalyst in the uncured polyurethane foam is 0.001 to 9 wt %, or 0.04 to 9 wt %, or 0.04 to 7 wt %, or 3 to 7 wt %, of catalyst, based on a total weight of the uncured polyurethane foam. Such catalysts include organic and inorganic acid salts of, or organometallic derivatives of bismuth, lead, tin, iron, antimony, uranium, cadmium, cobalt, thorium, aluminum, mercury, zinc, nickel, cerium, molybdenum, vanadium, copper, manganese, or zirconium, as well as phosphines or tertiary organic amines of these metals. Examples of such catalysts are dibutyltin dilaurate, dibutyltin diacetate, stannous octoate, lead octoate, cobalt naphthenate, bis(2,4-pentanedionate) nickel (II) or derivatives thereof such as diacetonitrilediacetylacetonato nickel, diphenylnitrilediacetylacetonato nickel, or bis(triphenylphosphine)diacetyl acetylacetonato nickel. The catalyst can comprise ferric acetylacetonate, triethylamine, tricthylenediamine, N,N,N′,N′-tetramethylethylenediamine, 1,1,3,3-tetramethylguanidine, N,N,N′N′-tetramethyl-1,3-butanediamine, N,N-dimethylethanolamine, N,N-diethylethanolamine, 1,3,5-tris(N,N-dimethylaminopropyl)-s-hexahydrotriazine, o- and p-(dimethylaminomethyl) phenols, 2,4,6-tris(dimethylaminomethyl) phenol, N,N-dimethylcyclohexylaminc, pentamethyldiethylenetriamine, 1,4-diazobicyclo[2.2.2]octane, N-hydroxyl-alkyl quaternary ammonium carboxylates and tetramethylammonium formate, tetramethylammonium acetate, or tetramethylammonium 2-ethylhexanoate. A catalyst delay agent can optionally be present, for example, as is described in U.S. Pat. Nos. 10,023,681, 9,228,047 and 5,733,945. A combination of at least two different catalysts can be used.

The reactive composition can comprise a surfactant that can stabilize the reactive composition before it is cured. The surfactant can comprise an organosilicone surfactant. The organosilicone can comprise a copolymer comprising or consisting essentially of SiO₂ (silicate) units and (CH₃)₃SiO_{0.5} (trimethylsiloxy) units in a molar ratio of silicate to trimethylsiloxy units of 0.8:1 to 2.2:1, or 1:1 to 2.0:1. The organosilicone can comprise a partially cross-linked siloxane-polyoxyalkylene block copolymer, wherein the siloxane blocks and polyoxyalkylenc blocks are linked by silicon to carbon, or by silicon to oxygen to carbon. The surfactant can be present in an amount of 0.5 to 12 wt %, or 5 to 10 wt %, based on the total weight of the active hydrogen component. The surfactant is present in an amount of 0.1 to 10 wt %, or 4 to 8 wt %, based on a total weight of the uncured polyurethane foam.

Other, optional additives can be added to the reactive composition. For example, the additive can comprise a filler (for example, alumina trihydrate, silica, talc, calcium carbonate, or clay), desiccant, dyes, pigments (for example, titanium dioxide or iron oxide), antioxidants, antiozonants, UV stabilizers, conductive fillers, or conductive polymers.

Methods for the manufacture of foams are generally known. The foams can be mechanically frothed, physically or chemically blown, or both. The polyurethane foams can be made by casting a mechanically frothed composition. In particular, the reactive precursors of the polyurethane can be mixed and mechanically, frothed, then cast to form a layer, and cured.

Physical blowing agents can be used alone or as mixtures with each other or with one or more chemical blowing agents. Physical blowing agents can be selected from a broad range of materials, including hydrocarbons, ethers, esters and partially halogenated hydrocarbons, ethers, and esters, and the like. Typical physical blowing agents have a boiling point of −50 to 100° C., or −50 to 50° C. Exemplary physical blowing agents include CFC's (chlorofluorocarbons) (for example, 1,1-dichloro-1-fluorocthane, 1,1-dichloro-2,2,2-trifluoro-ethanc, monochlorodifluoromethane, or 1-chloro-1,1-difluorocthanc); FC's (fluorocarbons) (for example, 1,1,1,3,3,3-hexafluoropropane, 2,2,4,4-tetrafluorobutane, 1,1,1,3,3,3-hexafluoro-2-methylpropane, 1,1,1,3,3-pentafluoropropane, 1,1,1,2,2-pentafluoropropane, 1,1,1,2,3-pentafluoropropane, 1,1,2,3,3-pentafluoropropane, 1,1,2,2,3-pentafluoropropane, 1,1,1,3,3,4-hexafluorobutane, 1,1,1,3,3-pentafluorobutane, 1,1,1,4,4,4-hexafluorobutane, 1,1,1,4,4-pentafluorobutane, 1,1,2,2,3,3-hexafluoropropane, 1,1,1,2,3,3-hexafluoropropane, 1,1-difluorocthane, 1,1,1,2-tetrafluoroethane, or pentafluoroethane); FE's (fluorocthers) (for example, methyl-1,1,1-trifluoroethylether or difluoromethyl-1,1,1-trifluoroethylether); or hydrocarbons (for example, n-pentane, isopentane, or cyclopentane). The physical blowing agent can comprise at least one of carbon dioxide, ethane, propane, n-butane, isobutane, pentane, hexane, butadiene, acetone, methylene chloride, any of the chlorofluorocarbons, hydrochlorofluorocarbons, or hydrofluorocarbons. As with the chemical blowing agents, the physical blowing agents can be used in an amount sufficient to give the resultant foam the desired bulk density. Typically, physical blowing agents are used in an amount of 5 to 50 wt %, or 10 to 30 wt %, based on the total weight of the reactive composition.

If a chemical blowing agent is used, it can comprise at least one of water, an azo compound (for example, azoisobutyronitrile, azodicarbonamide (i.e. azo-bis-formamide), or barium azodicarboxylate); a substituted hydrazine (for example, diphenylsulfone-3,3′-disulfohydrazide, 4,4′-hydroxy-bis-(benzenesulfohydrazide), trihydrazinotriazine, or aryl-bis-(sulfohydrazide)); a semicarbazide (for example, p-tolylene sulfonyl semicarbazide, or 4,4′-hydroxy-bis-(benzenesulfonyl semicarbazide)); a triazole (for example, 5-morpholyl-1,2,3,4-thiatriazole); an N-nitroso compound (for example, N,N′-dinitrosopentamethylene tetramine or N,N-dimethyl-N,N′-dinitrosophthalmide); benzoxazine (for example, isatoic anhydride); or a mixture (for example, a sodium carbonate/citric acid mixture). The chemical blowing agent can comprise water. The blowing agent can comprise at least one of an ammonium salt, a phosphate, a polyphosphate, a borate, a polyborate, a sulphate, a urea, a urea-formaldehyde resin, a dicyandiamide, or a melamine.

The amount of the foregoing chemical blowing agents will vary depending on the agent and the desired foam density, and is readily determinable by one of ordinary skill in the art. In general, these chemical blowing agents are used in an amount of 0.1 to 10 wt %, based on the total weight of the reactive composition. The decomposition products formed during the decomposition process can be physiologically safe, and that may not significantly adversely affect the thermal stability or mechanical properties of the foamed polyurethane sheets.

In an aspect, the polyurethane foam is produced by mechanically mixing the reactive composition (including the isocyanate component, the active hydrogen-containing component, a froth-stabilizing surfactant, the catalyst, and other optional additives) with a froth-forming gas. The frothed mixture can be fed onto a release liner and spread to a layer of desired thickness by a doctoring blade or other suitable spreading device. The gauged layer of the frothed mixture can then be delivered to one or more heating zones. After the heating zone, the formed polyurethane layer can be passed to a cooling zone.

For example, in the production of polyurethane foams, the reactive components of the polyurethane foam-forming composition can be formulated in two parts, one part (“Part A”) containing the active hydrogen-containing component and the disclosed flame retardant additives, the catalyst, the surfactant, and if used the inhibitor, and a chemical blowing agent; and the other part (“Part B”) containing the organic isocyanate component. The parts can be metered, mixed, and cast, for example, into a mold or a continuous coating line. The foaming and curing then occurs either in the mold or on the continuous coating line. In a method of production, the reactive components of the polyurethane foam-forming composition can be introduced into an extruder together with the disclosed flame retardant additives and a chemical blowing agent, a physical blowing agent, or other additives if used. The catalyst can then be metered into the extruder to start the foaming and curing reaction. The use of physical blowing agents such as liquid carbon dioxide or supercritical carbon dioxide in conjunction with chemical blowing agents such as water can give rise to foam having much lower densities.

In an aspect, 70 to 90 wt %, or 75 to 89 wt %, of the active hydrogen-containing component (“Part A”) and 10 to 30 wt %, or 11 to 25 wt %, of the isocyanate component (“Part B”) can be combined to form the uncured polyurethane foam. In an aspect, the disclosed flame retardant additives can also be added to the Part B.

The amount of the disclosed flame retardant additives can provide a desired degree of thermal barrier properties. The uncured polyurethane foam can include 3 to 68 wt %, or 14 to 36 wt %, of the disclosed flame retardant additives, based on the total weight of the uncured polyurethane foam.

The flame retardant foam can have a void volume content of 5 to 99%, for example, greater than or equal to 30%, based upon the total volume of the foam.

The flame retardant foam is flexible, and can maintain its elastic behavior over many cycles on compression deflection, properties reflected by compressive force deflection and compression set of the foam. Foams with good compression set resistance provide cushioning, and maintain their original shape or thickness under loads for extended periods. In an aspect, the flame retardant foam, e.g., the cured polyurethane foam, has a compression force deflection of 0.2 to 125 pounds per square inch (psi) (1 to 862 kilopascals (kPa)), or 0.25 to 20 psi (1.7 to 138 kPa), or 0.4 to 4 psi (2.8 to 28 kPa), or 0.5 to 2.5 psi (3.4 to 17 kPa), or 0.5 to less than 2.5 psi (3.4 to less than 17 kPa), or 0.5 to 2 psi (3.4 to 14 kPa), or 0.5 to 1.5 psi (3.4 to 10 kPa), or 0.5 to less than 1.5 psi (3.4 to less than 10 kPa), each at 25% deflection and determined in accordance with ASTM D3574-17. The flame retardant foam, e.g., the cured polyurethane foam, can have a compression set of 0 to 15%, or 0 to 10%, or 0 to 5%, or 0 to 4%, or 0 to less than 4%, or 0 to 2%, or 0 to less than 2%, or greater than 0 to 15%, or greater than 0 to 10%, or greater than 0 to 5%, or greater than 0 to 4%, or greater than 0 to less than 4%, or greater than 0 to 2%, or greater than 0 to less than 2%, determined in accordance with ASTM D 3574-95 Test D at 70° C.

In an aspect, the flame retardant foam, e.g., the cured polyurethane foam, has a compression force deflection of 0.4 to 4 psi (2.8 to 28 kPa), at 25% deflection and determined in accordance with ASTM D3574-17, or a compression set of 0 to 10%, determined in accordance with ASTM D 3574-95 Test D at 70° C.; or a compression force deflection of 0.4 to 4 psi (2.8 to 28 kPa), at 25% deflection and determined in accordance with ASTM D3574-17, and a compression set of 0 to 10%, determined in accordance with ASTM D 3574-95 Test D at 70° C.; or a compression force deflection of 0.5 to less than 1.5 psi (2.8 to less than 10 kPa), at 25% deflection and determined in accordance with ASTM D3574-17, and a compression set of 0 to less than 2%, determined in accordance with ASTM D 3574-95 Test D at 70° C.; or a compression force deflection of 0.4 to less than 2.5 psi (2.8 to less than 1728 kPa), at 25% deflection and determined in accordance with ASTM D3574-17, and a compression set of 0 to less than 4%, determined in accordance with ASTM D 3574-95 Test D at 70° C.

In an aspect, the flame retardant foam is used as a single layer with desirable flame retardancy. One advantage of the flame retardant foam is that a single sheet used alone can provide effective flame retardancy without other layers even at thicknesses of, for example, 2.7 to 8 mm, 2.8 to 8 mm, 3 to 8 mm, 2.7 to 7.5 mm, 2.8 to 7.5 mm, 3.5 to 7.5 mm, 4.1 to 7.5 mm, 2.7 to 6.3 mm, 2.8 to 6.3 mm, 3.5 to 6.3 mm, 4.2 to 6.3 mm, 4.5 to 7.5 mm, 2.7 to 7 mm, 2.8 to 7 mm, 5 to 7 mm, 5.8 to 6.3 mm, 2.7 to 6 mm, 2.8 to 6 mm, 3.5 to 6 mm, or 4 to 6 mm.

The flame retardant foam can have a UL 94 rating of V-0, for example, at a density of 10 lb/ft³ (160 kg/m³) and a thickness of 6 mm. The flame retardant foam can have a UL 94 rating of V-0, for example, at 10 1b/ft³ (160 kg/m³) at a thickness of 2.7 mm, 2.8 mm, 3.5 mm, or 4 mm.

The following examples are provided to illustrate the present disclosure. The examples are merely illustrative and are not intended to limit devices made in accordance with the disclosure to the materials, conditions, or process parameters set forth therein.

### EXAMPLES

Polyurethane foams were manufactured using methods as described in U.S. Pat. No. 7,338,983, in particular methods in accordance with Example 3 of this patent. The polyurethane foams were produced by mechanically mixing the reactive composition (including the isocyanate component, the active hydrogen-containing component, a froth-stabilizing surfactant, the catalyst, and other additives) with a froth-forming gas, nitrogen. The frothed mixture is fed onto a release liner and spread to a layer of desired thickness of, for example, 4-8 mm by a doctoring blade or other suitable spreading device. The gauged layer of the frothed mixture was then delivered to one or more heating zones, for example, less than or equal to 8 heating zones. After the heating zone, the formed polyurethane layer was passed to a cooling zone. The materials listed in Tables 1 and 2 were used in the Examples detailed in Tables 3 (wherein the mass in grams is listed), 4, and 5.

TABLE 1

| Category | Description |
|---|---|
| Blend1 | See Table 2 |
| isocyanate | polymeric methylene diphenyl diisocyanate (MDI), |
| | NCO content = 30-33 wt % |
| catalyst | catalyst for reaction of isocyanate and active |
| | hydrogen-containing component |
| surfactant | organosilicone surfactant |
| pigment | black pigment |

TABLE 2

| Category | Description | Mass ratio |
|---|---|---|
| polyol | Polyol blend including polyether polyol blend and optional polyester | 0.5028 |
| | polyol, chain extender (active hydrogen-containing component) | |
| desiccant | 3A molecular sieve powder (alkali metal alumino-silicate), <10 | 0.0240 |
| | micrometer particle size | |
| antioxidant | butylated hydroxytoluene antioxidant | 0.0007 |
| FR1 | expandable graphite, 50 to 80 mesh, 180 to 250° C. onset temperature | 0.2365 |
| | for expansion | |
| FR2 | ammonium polyphosphate, uncoated or coated with melamine or | 0.1892 |
| | silane, 7-20 micrometer particle size | |
| FR3 | liquid phosphate flame retardant. | 0.0468 |
| | Phenol, isobutylenated, phosphate [Triphenyl phosphate ≥ 2.5 < 25%] | |

TABLE 3

| Example | 1-5 | 6-9 | 10-12 | 13 |
|---|---|---|---|---|
| Blend1 | 0.6520 | 0.6520 | 0.6520 | 0.6729 |
| Isocyanate | 0.2024 | 0.2156 | 0.2250 | 0.2090 |
| Catalyst | 0.0582 | 0.0582 | 0.0582 | 0.0602 |
| Surfactant | 0.0728 | 0.0728 | 0.0728 | 0.0429 |
| Pigment | 0.0145 | 0.0145 | 0.0145 | 0.0150 |

The amount of surfactant and isocyanate ratio were varied between Examples. For example, the amount of surfactant helped provide desired density, e.g., cell structure, and the iso ratio, i.e., a stoichiometry ratio of isocyanate moieties to active hydrogen-containing groups, e.g., hydroxyl groups, in the uncured polyurethane foam, helped adjust CFD.

TABLE 4

| | | | | Compression | | |
|---|---|---|---|---|---|---|
| | | | | Load | | |
| | Density | Density | Thickness | Deflection | CLD | 50% |
| Example | (lb/ft³) | (kg/m³) | (mm) | (CLD) (psi) | (kPa) | C-set |
| 1 | 10.0 | 160 | 6.147 | 0.79 | 5.4 | 1.433 |
| 2 | 9.9 | 159 | 6.200 | 0.82 | 5.7 | 1.587 |
| 3 | 10.1 | 162 | 6.177 | 0.77 | 5.3 | 1.175 |
| 4 | 10.2 | 163 | 6.125 | 0.81 | 5.6 | 1.522 |
| 5 | 10.5 | 168 | 6.066 | 0.88 | 6.1 | 1.582 |
| 6 | 10.3 | 165 | 6.092 | 1.22 | 8.4 | 1.123 |
| 7 | 10.3 | 165 | 5.964 | 1.20 | 8.3 | 1.117 |
| 8 | 10.8 | 173 | 6.021 | 1.20 | 8.3 | 1.427 |
| 9 | 10.3 | 165 | 5.956 | 1.17 | 8.1 | 1.482 |
| 10 | 10.9 | 175 | 5.941 | 1.22 | 8.4 | 1.200 |
| 11 | 10.5 | 168 | 5.865 | 1.37 | 9.4 | 1.213 |
| 12 | 10.6 | 170 | 5.831 | 1.41 | 9.7 | 1.484 |
| 13 | 9.4 | 151 | 4.166 | 0.89 | 6.1 | 1.7 |

TABLE 5

| | Tensile | Tensile | Elongation | Notch tear | Notch tear | |
|---|---|---|---|---|---|---|
| Example | (psi) | (kPa) | % | (pounds/inch) | (N/mm) | V-0 |
| 1 | 13.9 | 95.8 | 100.0 | 2.7 | 0.47 | Pass |
| 2 | 13.8 | 95.1 | 92.2 | 2.5 | 0.44 | Pass |
| 3 | 14.0 | 96.5 | 98.3 | 2.6 | 0.46 | Pass |
| 4 | 14.2 | 97.9 | 98.8 | 2.7 | 0.47 | Pass |
| 5 | 14.6 | 100.7 | 98.2 | 2.7 | 0.47 | Pass |
| 6 | 19.3 | 133.1 | 97.3 | 3.4 | 0.60 | Pass |
| 7 | 19.4 | 133.8 | 100.5 | 3.1 | 0.54 | Pass |
| 8 | 18.8 | 129.6 | 95.1 | 3.4 | 0.60 | Pass |
| 9 | 18.4 | 126.9 | 90.8 | 3.0 | 0.53 | Pass |
| 10 | 19.5 | 134.4 | 99.0 | 3.2 | 0.56 | Pass |
| 11 | 22.0 | 151.7 | 100.9 | 3.6 | 0.63 | Pass |
| 12 | 22.0 | 151.7 | 91.4 | 3.8 | 0.67 | Pass |
| 13 | 28.7 | 197.9 | 109 | 5.02 | 0.88 | Pass |

Examples 1-13 demonstrate that a polyurethane foam with the disclosed flame retardant additives can achieve a V-0 flame rating at a density of 9 to 11 lb/ft³ (144 to 176 kg/m³) at a thickness of, for example, 6 mm. The polyurethane foam can have a compression force deflection of less than 1.5 psi, at 25% deflection and determined in accordance with ASTM D3574-17, and a compression set of less than 2%, determined in accordance with ASTM D 3574-95 Test D at 70° C. Example 13 demonstrates that V-0 flame rating can be achieved at a density of 9.4 lb/ft³ at a thickness of 4 mm.

The materials listed in Tables 6 and 7 were used in the Examples detailed in Tables 8 (wherein the mass in grams is listed), 9, and 10.

TABLE 6

| Category | Description |
|---|---|
| Blend2 | See Table 7 |
| isocyanate | polymeric methylene diphenyl diisocyanate |
| | (MDI), NCO content = 30-33 wt % |
| catalyst | catalyst for reaction of isocyanate and |
| | active hydrogen-containing component |
| surfactant | organosilicone surfactant |
| pigment | black pigment |

TABLE 7

| Category | Description | Mass ratio |
|---|---|---|
| polyol | Polyol blend including polyether polyol blend and optional | 0.5275 |
| | polyester polyol, chain extender (active hydrogen-containing | |
| | component) | |
| desiccant | 3A molecular sieve powder (alkali metal alumino-silicate), <10 | 0.0252 |
| | micrometer particle size | |
| antioxidant | butylated hydroxytoluene antioxidant | 0.0007 |
| FR1 | expandable graphite, 50 to 80 mesh, 180 to 250° C. onset | 0.2481 |
| | temperature for expansion | |
| FR2 | ammonium polyphosphate, uncoated or coated with melamine | 0.1985 |
| | or silane, 7-20 micrometer particle size | |

TABLE 8

| Example | 14 | 15 | 16 | 17 | 18 | 19 | 20 | 21 | 22-26 |
|---|---|---|---|---|---|---|---|---|---|
| Blend2 | 0.6520 | 0.6520 | 0.6520 | 0.6520 | 0.6562 | 0.6509 | 0.6471 | 0.6433 | 0.6670 |
| Isocyanate | 0.2024 | 0.1963 | 0.1905 | 0.1935 | 0.2009 | 0.2073 | 0.2120 | 0.2166 | 0.2158 |
| Catalyst | 0.0582 | 0.0582 | 0.0582 | 0.0582 | 0.0586 | 0.0582 | 0.0578 | 0.0575 | 0.0598 |
| Surfactant | 0.0720 | 0.0720 | 0.0720 | 0.0720 | 0.0697 | 0.0691 | 0.0687 | 0.0683 | 0.0425 |
| Pigment | 0.0145 | 0.0145 | 0.0145 | 0.0145 | 0.0146 | 0.0145 | 0.0144 | 0.0143 | 0.0149 |

TABLE 9

| | Density | Density | Thickness | CLD | CLD | 50% |
|---|---|---|---|---|---|---|
| Example | (lb/ft³) | (kg/m³) | (mm) | (psi) | (kPa) | C-set |
| 14 | 9.8 | 157 | 6.194 | 0.81 | 5.6 | 1.425 |
| 15 | 10.5 | 168 | 6.243 | 0.61 | 4.2 | 3.212 |
| 16 | 10.5 | 168 | 6.086 | 0.47 | 3.2 | 3.999 |
| 17 | 10.4 | 167 | 6.250 | 0.57 | 3.9 | 3.038 |
| 18 | 9.0 | 144 | 6.10 | 1.11 | 7.7 | 2.0 |
| 19 | 9.1 | 146 | 6.17 | 0.98 | 6.8 | 1.7 |
| 20 | 9.2 | 147 | 6.29 | 1.20 | 8.3 | 1.2 |
| 21 | 9.5 | 152 | 6.02 | 0.76 | 5.2 | 1.1 |
| 22 | 9.5 | 152 | 5.49 | 2.36 | 16.3 | 1.2 |
| 23 | 9.5 | 152 | 5.00 | 2.31 | 15.9 | 1.4 |
| 24 | 9.6 | 154 | 4.47 | 2.32 | 16.0 | 1.1 |
| 25 | 9.6 | 154 | 3.89 | 2.31 | 15.9 | 1.4 |
| 26 | 9.5 | 152 | 3.48 | 1.99 | 13.7 | 0.9 |

TABLE 10

| | Tensile | Tensile | Elongation | Notch tear | Notch tear | |
|---|---|---|---|---|---|---|
| Example | (psi) | (kPa) | % | (pounds/inch) | (N/mm) | V-0 |
| 14 | 17.0 | 117.2 | 155.0 | 2.8 | 0.49 | Pass |
| 15 | 14.1 | 97.2 | 146.8 | 2.5 | 0.44 | Pass |
| 16 | 12.8 | 88.3 | 160.8 | 2.3 | 0.40 | Pass |
| 17 | 13.3 | 91.7 | 147.2 | 2.5 | 0.44 | Pass |
| 18 | 14.0 | 96.5 | 151 | 2.8 | 0.49 | Pass |
| 19 | 15.8 | 108.9 | 149 | 3.7 | 0.65 | Pass |
| 20 | 19.4 | 133.8 | 137 | 3.5 | 0.61 | Pass |
| 21 | 19.7 | 135.8 | 145 | 3.8 | 0.67 | Pass |
| 22 | 42.5 | 293 | 103 | 5.2 | 0.92 | Pass |
| 23 | 41.4 | 285 | 100 | 4.7 | 0.83 | Pass |
| 24 | 42.6 | 294 | 99 | 5.6 | 0.98 | Pass |
| 25 | 42.3 | 292 | 98 | 5.1 | 0.89 | Pass |
| 26 | 42.1 | 290 | 88 | 5.0 | 0.88 | Pass |

Examples 14-26 demonstrate that V-0 flame rating can be achieved at a density of 9 to 11 lb/ft³ (144 to 176 kg/m³) at a thickness of, for example, 6 mm. The polyurethane foam can have a compression force deflection of less than 2.5 psi, at 25% deflection and determined in accordance with ASTM D3574-17, and a compression set of less than 4%, determined in accordance with ASTM D 3574-95 Test D at 70° C. Examples 14-26 demonstrate that V-0 flame rating can be achieved at a density of 9 to 11 1b/ft³ (144 to 176 kg/m³), for example, 9.0 to 10.5 1b/ft³ (144 to 168 kg/m³) or 9.8 to 10.4 1b/ft³ (157 to 167 kg/m³), without FR3, which can be considered optional. Example 26 demonstrates that V-0 flame rating can be achieved at a density of 9.5 lb/ft³ at a thickness of 3.5 mm.

The materials listed in Tables 11 and 12 were used in the Examples detailed in Tables 13 and 14.

TABLE 11

| Category | Description | Mass ratio |
|---|---|---|
| Blend3 | See Table 12 | 0.6990 |
| isocyanate | polymeric methylene diphenyl diisocyanate | 0.2097 |
| | (MDI), NCO content = 30-33 wt % | |
| catalyst | catalyst for reaction of isocyanate and | 0.0539 |
| | active hydrogen-containing component | |
| surfactant | organosilicone surfactant | 0.0374 |

TABLE 12

| Category | Description | Mass (g) |
|---|---|---|
| polyol | Polyol blend including polyether polyol blend, optional | 0.3800 |
| | polyester polyol, and optional chain extender (active hydrogen- | |
| | containing component) | |
| desiccant | 3A molecular sieve powder (alkali metal alumino-silicate), <10 | 0.0114 |
| | micrometer particle size | |
| antioxidant | butylated hydroxytoluene antioxidant | 0.0004 |
| FR1 | expandable graphite, 50 to 80 mesh, 180 to 250° C. onset | 0.1536 |
| | temperature for expansion | |
| FR2 | ammonium polyphosphate, uncoated or coated with melamine or | 0.1229 |
| | silane, 7-20 micrometer particle size | |
| FR3 | liquid phosphate flame retardant. | 0.0307 |
| | Phenol, isobutylenated, phosphate [Triphenyl phosphate ≥ 2.5 < | |
| | 25%] | |
| | TOTAL | 0.6990 |

TABLE 13

| | Density | Density | Thickness | CLD | CLD | 50% C-set |
|---|---|---|---|---|---|---|
| Example | (lb/ft³) | (kg/m³) | (mm) | (psi) | (kPa) | (%) |
| 27 | 9.8 | 157 | 4.039 | 0.64 | 4.4 | 4.8 |
| 28 | 9.5 | 152 | 6.045 | 0.61 | 4.2 | 5.1 |

TABLE 14

| | Tensile | Tensile | Elongation | Notch tear | Notch tear | |
|---|---|---|---|---|---|---|
| Example | (psi) | (kPa) | % | (pounds/inch) | (N/mm) | V-0 |
| 27 | 25.5 | 175.8 | 171 | 4.77 | 0.84 | Pass |
| 28 | 23.0 | 158.6 | 175 | 4.54 | 0.80 | Pass |

Example 27 demonstrates that V-0 flame rating can be achieved at a density of 9 to 11 1b/ft³ (144 to 176 kg/m³) at a thickness of, for example, 4 mm. Example 28 demonstrates that V-0 flame rating can be achieved at a density of, for example, 9.5 lb/ft³ (152 kg/m³) at a thickness of, for example, 6 mm.

The materials listed in Tables 15 and 16 were used in the Examples detailed in Tables 17 and 18.

TABLE 15

| Category | Description | Mass ratio |
|---|---|---|
| Blend4 | See Table 16 | 0.7128 |
| isocyanate | polymeric methylene diphenyl diisocyanate | 0.1968 |
| | (MDI), NCO content = 30-33 wt % | |
| catalyst | catalyst for reaction of isocyanate | 0.0494 |
| | and active hydrogen-containing component | |
| surfactant | organosilicone surfactant | 0.0410 |

TABLE 16

| Category | Description | Mass (g) |
|---|---|---|
| polyol | Polyol blend including polyether polyol blend, optional | 0.4054 |
| | polyester polyol, and optional chain extender (active | |
| | hydrogen-containing component) | |
| desiccant | 3A molecular sieve powder (alkali metal alumino- | 0.0121 |
| | silicate), <10 micrometer particle size | |
| antioxidant | butylated hydroxytoluene antioxidant | 0.0004 |
| FR1 | expandable graphite, 50 to 80 mesh, 180 to 250° C. onset | 0.1639 |
| | temperature for expansion | |
| FR2 | ammonium polyphosphate, uncoated or coated with | 0.1311 |
| | melamine or silane, 7-20 micrometer particle size | |
| | TOTAL | 0.7129 |

TABLE 17

| | Density | Density | Thickness | CLD | CLD | 50% C-set |
|---|---|---|---|---|---|---|
| Example | (lb/ft³) | (kg/m³) | (mm) | (psi) | (kPa) | (%) |
| 29 | 9.2 | 147 | 4.369 | 0.71 | 4.9 | 3.8 |

TABLE 18

| | Tensile | Tensile | Elongation | Notch tear | Notch tear | |
|---|---|---|---|---|---|---|
| Example | (psi) | (kPa) | % | (pounds/inch) | (N/mm) | V-0 |
| 29 | 33.4 | 230.3 | 170 | 5.83 | 1.02 | Pass |

Example 29 demonstrates that V-0 flame rating can be achieved at a density of 9 to 11 1b/ft³ (144 to 176 kg/m³), for example, 9.2 1b/ft³ (147 kg/m³), at a thickness of, for example, 4.3 mm. Example 29 demonstrates that V-0 flame rating can be achieved at a density of 9 to 11 1b/ft³ (144 to 176 kg/m³), or 9 to 10 1b/ft³ (144 to 160 kg/m³), for example, 9.2 1b/ft³ (147 kg/m³), without FR3, which can be considered optional.

The materials listed in Tables 6 and 7 were used in Example 30, detailed in Tables 19 (wherein the mass in grams is listed) 20, and 21.

TABLE 19

| Example | 30 |
|---|---|
| Blend2 | 0.6471 |
| Isocyanate | 0.2120 |
| Catalyst | 0.0578 |
| Surfactant | 0.0687 |
| Pigment | 0.0144 |

TABLE 20

| | Density | Density | Thickness | CLD | CLD | 50% C-set |
|---|---|---|---|---|---|---|
| Example | (lb/ft³) | (kg/m³) | (mm) | (psi) | (kPa) | (%) |
| 30 | 10.1 | 162 | 2.832 | 1.5 | 10.4 | 1.6 |

TABLE 21

| | Tensile | Tensile | Elongation | Notch tear | Notch tear | |
|---|---|---|---|---|---|---|
| Example | (psi) | (kPa) | % | (pounds/inch) | (N/mm) | V-0 |
| 30 | 34.3 | 236.5 | 133 | 6 | 1.05 | Pass |

Example 30 demonstrates that V-0 flame rating can be achieved at a density of 9 to 11 lb/ft³ (144 to 176 kg/m³), for example, 9.0 to 10.5 lb/ft³ (144 to 168 kg/m³), 9.8 to 10.4 1b/ft³ (157 to 167 kg/m³), or 10.1 1b/ft³ (147 kg/m³), at a thickness of, for example, 2.8 mm.

An acceptable thickness tolerance for UL certification for a 2.7 mm thickness is +/−0.15 mm, and a thickness of 2.832 mm can be certified as 2.7 mm. Similarly, Example 30 demonstrates that V-0 flame rating can be achieved at a density of 9 to 11 lb/ft³ (144 to 176 kg/m³), for example, 9.0 to 10.5 lb/ft³ (144 to 168 kg/m³), 9.8 to 10.4 lb/ft³ (157 to 167 kg/m³), or 10.1 1b/ft³ (147 kg/m³), at a thickness of 2.7 mm.

An acceptable thickness tolerance for UL certification for a 3.0 mm thickness is +/−0.25 mm, and a thickness of 3.25 mm can be certified as 3.0 mm. An acceptable thickness tolerance for UL certification for a 3.6 mm thickness is +/−0.25 mm, and a thickness of 3.85 mm can be certified as 3.6 mm.

An acceptable thickness tolerance for UL certification for a 4.0 mm thickness is +/−0.25 mm, and a thickness of 4.25 mm (or 4.039 mm, see Example 27, or 4.166 mm, see Example 13) can be certified as 4.0 mm. Similarly, Example 13 demonstrates that V-0 flame rating can be achieved at a density of 9 to 11 lb/ft³ (144 to 176 kg/m³), for example, 9.0 to 10.5 1b/ft³ (144 to 168 kg/m³), or 9.4 lb/ft³ (151 kg/m³), at a thickness of 4.0 mm, and Example 27 demonstrates that V-0 flame rating can be achieved at a density of 9 to 11 lb/ft³ (144 to 176 kg/m³), for example, 9.0 to 10.5 lb/ft³ (144 to 168 kg/m³), 9.8 to 10.4 lb/ft³ (157 to 167 kg/m³), or 9.8 lb/ft³ (157 kg/m³), at a thickness of 4.0 mm.

An acceptable thickness tolerance for UL certification for a 4.5 mm thickness is +/−0.40 mm, and a thickness of 4.9 mm can be certified as 4.5 mm. An acceptable thickness tolerance for UL certification for a 10.0 mm thickness is +/−0.40 mm, and a thickness of 10.4 mm can be certified as 10.0 mm.

Set forth below are non-limiting aspects of this disclosure.

Aspect 1: A flame retardant foam comprising polyurethane and flame retardant additives, wherein the flame retardant foam has a density of 8 to less than 11.7 pounds per cubic foot (128 to less than 187 kilograms per cubic meter), a thickness of 2.7 to 8 millimeters, or 2.8 to 8 millimeters, or 3 to 8 millimeters, and a UL 94 rating of V-0.

Aspect 2: The flame retardant foam of aspect 1, wherein the flame retardant foam has a density of 9 to 11 pounds per cubic foot (144 to 176 kilograms per cubic meter).

Aspect 3: The flame retardant foam of aspect 1, wherein the flame retardant foam has a thickness of 3 to 8 millimeters.

Aspect 4: The flame retardant foam of aspect 1, wherein the flame retardant foam has a thickness of 3.5 to 7.5 millimeters.

Aspect 5: The flame retardant foam of aspect 1, wherein the flame retardant foam has a thickness of 5 to 7 millimeters.

Aspect 6: The flame retardant foam of aspect 1, wherein the flame retardant foam has a density of 9.4 to 10.9 pounds per cubic foot (151 to 175 kilograms per cubic meter), and a thickness of 3.5 to 6.3 millimeters.

Aspect 7: The flame retardant foam of aspect 1, wherein the flame retardant foam has a density of 8 to less than 9.9 pounds per cubic foot (128 to less than 159 kilograms per cubic meter).

Aspect 8: The flame retardant foam of aspect 1, wherein the flame retardant foam has a density of 9.0 to 9.8 pounds per cubic foot (147 to 157 kilograms per cubic meter), and a thickness of 3.5 to 6 millimeters.

Aspect 9: The flame retardant foam of aspect 1, wherein the flame retardant additives comprise graphite and ammonium polyphosphate.

Aspect 10: The flame retardant foam of aspect 1, wherein the flame retardant foam has a compression force deflection of 0.4 to 4 pounds per square inch (2.8 to 28 kilopascals), at 25% deflection and determined in accordance with ASTM D3574-17, a compression set of 0 to 10%, determined in accordance with ASTM D 3574-95 Test D at 70° C., or a combination thereof.

Aspect 11: A method of forming the flame retardant foam of aspect 1, the method comprising combining an active hydrogen-containing component comprising a polyol, an isocyanate component comprising a polyisocyanate, and the flame retardant additives to form an uncured polyurethane foam; and curing the uncured polyurethane foam to form the flame retardant foam.

Aspect 12: The method of aspect 11, further comprising mechanically frothing the uncured polyurethane foam.

Aspect 13: The method of aspect 11, further comprising chemically blowing the uncured polyurethane foam.

Aspect 14: The method of aspect 11, wherein the graphite comprises expandable graphite, 50 to 80 mesh size, and having a 180 to 250° C. onset temperature for expansion.

Aspect 15: The method of aspect 11, wherein the ammonium polyphosphate is uncoated or coated with melamine or silane and has a particle size of 7 to 20 micrometers.

Aspect 16: The method of aspect 11, wherein the uncured polyurethane foam comprises 5 to 30 weight percent, or 10 to 20 weight percent, or 14 to 18 weight percent, of the graphite, based on a total weight of the uncured polyurethane foam.

Aspect 17: The method of aspect 11, wherein the uncured polyurethane foam comprises 5 to 30 weight percent, or 5 to 20 weight percent, or 10 to 15 weight percent, of the ammonium polyphosphate, based on a total weight of the uncured polyurethane foam.

Aspect 18: The method of aspect 11, wherein the flame retardant additives further comprise a liquid phosphate flame retardant.

Aspect 19: The method of aspect 18, wherein the liquid phosphate flame retardant comprises phenol, isobutylenated, phosphate (3:1) with 2.5 to 25 weight percent of triphenyl phosphate.

Aspect 20: The method of aspect 18, wherein the uncured polyurethane foam comprises 0.1 to 15 weight percent, or 0.5 to 10 weight percent, or 1 to 5 weight percent, of the liquid phosphate flame retardant, based on a total weight of the uncured polyurethane foam.

Aspect 21: The method of aspect 18, wherein the liquid phosphate flame retardant comprises phenol, isobutylenated, phosphate (3:1) with 2.5 to 25 weight percent of triphenyl phosphate; and the uncured polyurethane foam comprises 0.1 to 15 weight percent, or 0.5 to 10 weight percent, or 1 to 5 weight percent, of the liquid phosphate flame retardant, based on a total weight of the uncured polyurethane foam.

Aspect 22: The method of aspect 11, wherein the uncured polyurethane foam further comprises 0.1 to 10 weight percent, or 4 to 8 weight percent, of surfactant, based on a total weight of the uncured polyurethane foam.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

The terms “a” and “an” do not denote a limitation of quantity, but rather denote the presence of at least one of the referenced items. Thus, reference to “an” element in a claim followed by reference to “the” element is inclusive of one element and a plurality of the elements. The term “or” means “and/or” unless clearly indicated otherwise by context. Reference throughout the specification to “an aspect,” “another aspect,” and so forth, means that a particular element (e.g., feature, structure, step, or characteristic) described in connection with the aspect is included in at least an aspect described herein, and may or may not be present in other aspects. In addition, it is to be understood that the described elements can be combined in any suitable manner in the various aspects.

When an element such as a layer, film, region, or substrate is referred to as being “on” another element, it can be directly on the other element or intervening elements can also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the carliest priority application in which the test standard appears.

The endpoints of all ranges directed to the same component or property are inclusive of the endpoints, are independently combinable, and include all intermediate points and ranges. For example, ranges of “up to 25 wt %, or 5 to 20 wt %” is inclusive of the endpoints and all intermediate values of the ranges of “5 to 25 wt %,” such as 10 to 23 wt %, etc.). The terms “first,” “second,” and the like, “primary,” “secondary,” and the like, as used herein do not denote any order, quantity, or importance, but rather are used to distinguish one element from another. The term “combination thereof” is open, and means that the list is inclusive of each element individually, as well as combinations of two or more elements of the list, and combinations of at least one element of the list with like elements not named. Also, the term “combination” is inclusive of blends, mixtures, alloys, reaction products, and the like.

Unless defined otherwise, technical and scientific terms used herein have the same meaning as is commonly understood by one of skill in the art to which this disclosure belongs.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

In the drawings, the widths and thicknesses of layers and regions can be exaggerated for clarity of the specification and convenience of explanation. Like reference numerals in the drawings denote like elements.

While particular aspects have been described, alternatives, modifications, variations, improvements, and substantial equivalents that are or can be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A flame retardant foam comprising:
polyurethane; and
flame retardant additives,
wherein the flame retardant foam has
a density of 8 to less than 11.7 pounds per cubic foot (128 to less than 187 kilograms per cubic meter),
a thickness of 2.7 to 8 millimeters, or 2.8 to 8 millimeters, or 3 to 8 millimeters, and
a UL 94 rating of V-0.

2. The flame retardant foam of claim 1, wherein the flame retardant foam has a density of 9 to 11 pounds per cubic foot (144 to 176 kilograms per cubic meter).

3. The flame retardant foam of claim 1, wherein the flame retardant foam has a thickness of 3 to 8 millimeters.

4. The flame retardant foam of claim 1, wherein the flame retardant foam has a thickness of 3.5 to 7.5 millimeters.

5. The flame retardant foam of claim 1, wherein the flame retardant foam has a thickness of 5 to 7 millimeters.

6. The flame retardant foam of claim 1, wherein the flame retardant foam has
a density of 9.4 to 10.9 pounds per cubic foot (151 to 175 kilograms per cubic meter), and
a thickness of 3.5 to 6.3 millimeters.

7. The flame retardant foam of claim 1, wherein the flame retardant foam has a density of 8 to less than 9.9 pounds per cubic foot (128 to less than 159 kilograms per cubic meter).

8. The flame retardant foam of claim 1, wherein the flame retardant foam has
a density of 9.0 to 9.8 pounds per cubic foot (147 to 157 kilograms per cubic meter), and
a thickness of 3.5 to 6 millimeters.

9. The flame retardant foam of claim 1, wherein the flame retardant additives comprise:
graphite; and
ammonium polyphosphate.

10. The flame retardant foam of claim 1, wherein the flame retardant foam has
a compression force deflection of 0.4 to 4 pounds per square inch (2.8 to 28 kilopascals), at 25% deflection and determined in accordance with ASTM D3574-17,
a compression set of 0 to 10%, determined in accordance with ASTM D 3574-95 Test D at 70° C., or
a combination thereof.

11. A method of forming the flame retardant foam of claim 1, the method comprising:
combining an active hydrogen-containing component comprising a polyol, an isocyanate component comprising a polyisocyanate, and the flame retardant additives to form an uncured polyurethane foam; and
curing the uncured polyurethane foam to form the flame retardant foam.

12. The method of claim 11, further comprising mechanically frothing the uncured polyurethane foam.

13. The method of claim 11, further comprising chemically blowing the uncured polyurethane foam.

14. The method of claim 11, wherein the graphite comprises expandable graphite, 50 to 80 mesh size, and having a 180 to 250° C. onset temperature for expansion.

15. The method of claim 11, wherein the ammonium polyphosphate is uncoated or coated with melamine or silane and has a particle size of 7 to 20 micrometers.

16. The method of claim 11, wherein the uncured polyurethane foam comprises 5 to 30 weight percent, or 10 to 20 weight percent, or 14 to 18 weight percent, of the graphite, based on a total weight of the uncured polyurethane foam.

17. The method of claim 11, wherein the uncured polyurethane foam comprises 5 to 30 weight percent, or 5 to 20 weight percent, or 10 to 15 weight percent, of the ammonium polyphosphate, based on a total weight of the uncured polyurethane foam.

18. The method of claim 11, wherein the flame retardant additives further comprise a liquid phosphate flame retardant.

19. The method of claim 18, wherein:
the liquid phosphate flame retardant comprises phenol, isobutylenated, phosphate (3:1) with 2.5 to 25 weight percent of triphenyl phosphate;
the uncured polyurethane foam comprises 0.1 to 15 weight percent, or 0.5 to 10 weight percent, or 1 to 5 weight percent, of the liquid phosphate flame retardant, based on a total weight of the uncured polyurethane foam; or
a combination thereof.

20. The method of claim 11, wherein the uncured polyurethane foam further comprises 0.1 to 10 weight percent, or 4 to 8 weight percent, of surfactant, based on a total weight of the uncured polyurethane foam.
